(19) United States
(12) Patent Application Publication
(10) Pub. No.: US 2026/0302151 A1
(43) Pub. Date: Oct. 1, 2026

(54) SAMPLE SUPPORT AND METHOD FOR MANUFACTURING SAMPLE SUPPORT

(71) Applicant: HAMAMATSU PHOTONICS K.K., Hamamatsu-shi, Shizuoka (JP)

(72) Inventor: Takamasa IKEDA, Shizuoka (JP)

(73) Assignee: HAMAMATSU PHOTONICS K.K., Hamamatsu-shi, Shizuoka (JP)

(21) Appl. No.: 19/489,427

(22) PCT Filed: Feb. 2, 2024
(86) PCT No.: PCT/JP2024/003550

§ 371 Date: Dec. 2, 2025

(30) Foreign Application Priority Data
Jun. 7, 2023 (JP) 2023-093792

(51) Int. Cl. H01J 49/04

(52) U.S. Cl. CPC H01J 49/0418

(57) ABSTRACT

A sample support is a sample support for ionizing a sample. The sample support includes a substrate having a first surface, a second surface opposite to the first surface, and an irregular porous structure opening to at least the first surface. The porous structure is formed of a plurality of large particles connected to each other and a plurality of small particles having a diameter smaller than that of the large particles. At least a part of the plurality of small particles is held between two or more of the large particles constituting the first surface.

### TECHNICAL FIELD

The present disclosure relates to a sample support and a method for manufacturing the sample support.

### BACKGROUND ART

Desorption Electrospray Ionization (DESI) is known as a method for ionizing a sample such as a biological sample. Also, as a sample support suitable for such a desorption electrospray ionization method, a sample support including a substrate having a first surface, a second surface opposite to the first surface, and an irregular porous structure opening to at least the first surface is known (see, for example, Patent Literature 1). In the sample support, for example, a sample transferred onto the first surface is irradiated with charged-droplets, whereby desorption and ionization of the sample are performed.

### CITATION LIST

### Patent Literature

Patent Literature 1: JP 2022-43571 A

### SUMMARY OF INVENTION

### Technical Problem

In the sample support as described above, it is required to improve the detection sensitivity of a component of a sample in mass spectrometry or the like using an ionization method such as the above-described desorption electrospray ionization method.

An object of the present disclosure is to provide a sample support and a method for manufacturing the sample support, which can effectively improve the detection sensitivity of a component of a sample.

### Solution to Problem

The present disclosure includes the following sample supports [1] to [9] and a method for manufacturing a sample support [10].

[1] A sample support for ionizing a sample, including: a substrate having a first surface, a second surface opposite to the first surface, and an irregular porous structure opening to at least the first surface, wherein the porous structure is formed of a plurality of first particles connected to each other and a plurality of second particles having a diameter smaller than that of the first particles, and at least a part of the plurality of second particles is held between two or more of the first particles constituting the first surface.

In the sample support of [1] described above, the porous structure includes not only the plurality of first particles but also the second particles held between two or more of the first particles constituting the first surface. This can reduce a gap (that is, a space where no particles constituting the porous structure exist) of the sample support on the first surface when the sample support is viewed from a direction facing the first surface. In addition, on the first surface, not only joints between the first particles but also joints between the first particles and the second particles and joints between the second particles are added. This allows a sample to be measured to be suitably retained on the first surface (particularly on the joints described above). Therefore, according to the sample support of [1] described above, since a component of the sample retained on the first surface can be efficiently ionized, the detection sensitivity of the component of the sample can be effectively improved.

[2] The sample support according to [1], wherein the second particles are formed of a same material as the first particles.

If the first particles and the second particles are formed of different materials from each other, a signal derived from a material (material of the second particles) different from a base material (material of the first particles) may be generated as noise during ionization. According to the configuration of [2] described above, the occurrence of the problem as described above can be avoided. In addition, since the melting points and the coefficients of thermal expansion of the first particles and the second particles are equal, the substrate (irregular porous structure) can be manufactured easily and with stable quality.

[3] The sample support according to [2], wherein the first particles and the second particles are formed of an insulating material.

According to the configuration of [3] described above, the substrate in which the plurality of first particles and the plurality of second particles are integrated can be manufactured by an easy method such as sintering.

[4] The sample support according to [3], wherein the insulating material is glass.

According to the configuration of [4] described above, by forming the first particles and the second particles with glass having a relatively low melting point among insulating materials, a substrate having an irregular porous structure can be suitably and inexpensively obtained.

[5] The sample support according to any one of [1] to [4], wherein when the first surface is viewed from a position facing the first surface along a direction in which the first surface and the second surface face each other, the following formula (1) is satisfied, where R1 is an average particle size of the first particles included in a unit area of a predetermined size, and R2 is an average particle size of the second particles included in the unit area.

$$R 1 \times 1 / 100 \leq R 2 \leq R 1 \times 1 / 2 \qquad ( 1 )$$

According to the configuration of [5] described above, a configuration in which one or more second particles are held between two or more first particles constituting the first surface can be suitably realized. As a result, the effect of improving the detection sensitivity as described above can be suitably obtained.

[6] The sample support according to any one of [1] to [5], wherein the substrate includes: a first layer including the first surface, in which a plurality of the first particles and a plurality of the second particles coexist; and a second layer located closer to the second surface than the first layer, consisting of a plurality of the first particles, and not including the second particles.

In the configuration of [6] described above, while the first layer in which the first particles and the second particles coexist is provided to easily retain the sample on the first surface, the second layer, through which a liquid can pass more easily than the first layer by not including the second particles, is provided below the first layer (on the second surface side). This can suppress the measurement (ionization of the component of the sample retained on the first surface) from being hindered by an excess liquid component overflowing on the first surface, for example, when a sample to be measured containing a liquid component is transferred or dropped onto the first surface of the sample support.

[7] The sample support according to [6], wherein a thickness of the first layer in a first direction in which the first surface and the second surface face each other is one-fifth or less of a thickness of the second layer in the first direction.

According to the configuration of [7] described above, by sufficiently securing the thickness of the second layer with respect to the first layer, the effect of [6] described above can be suitably obtained.

[8] The sample support according to [6] or [7], wherein the substrate further includes a third layer including the second surface, in which a plurality of the first particles and a plurality of the second particles coexist, the second layer is located between the first layer and the third layer, and at least a part of the plurality of second particles included in the third layer is held between two or more of the first particles constituting the second surface.

According to the configuration of [8] described above, both the first surface and the second surface can be used as a measurement surface (that is, a surface that supports the sample to be measured). This improves convenience because a user (measurer) of the sample support does not need to identify which surface of the sample support is the measurement surface when transferring or dropping the sample to be measured onto the sample support.

[9] The sample support according to any one of [1] to [8], further including a conductive layer that covers the first surface along an uneven shape of the first surface configured by the first particles and the second particles, without blocking openings of the porous structure on the first surface.

According to the configuration of [9] described above, the sample support can be used for a laser desorption/ionization method or the like without impairing the effect of [1]. More specifically, when a laser desorption/ionization method or the like is used, that is, when it is necessary to apply a voltage to the first surface to guide the component of the sample ionized on the first surface to an ion detector (ground electrode), a voltage can be appropriately applied via the conductive layer.

[10] A method for manufacturing the sample support according to any one of [1] to [9], including: a first sintering step of sintering the plurality of first particles to obtain a sintered body having substantially same outer shape as the substrate; an adding step of adding the plurality of second particles to a surface of the sintered body corresponding to the first surface; and a second sintering step of sintering the sintered body and the plurality of second particles obtained by the adding step to obtain the porous structure.

According to the manufacturing method of [10] described above, a highly reliable porous structure can be obtained by performing a two-step sintering process. That is, by first obtaining a structure having high strength and stability only with the plurality of first particles in the first sintering step, and then performing the adding step and the second sintering step, the sample support exhibiting the effect of [1] described above can be easily and stably obtained.

### Advantageous Effects of Invention

According to the present disclosure, it is possible to provide a sample support and a method for manufacturing the sample support, which can effectively improve the detection sensitivity of a component of a sample.

### BRIEF DESCRIPTION OF DRAWINGS

FIG. 1 is a perspective view showing a sample support of an embodiment.

FIG. 2 is an SEM image of a region A shown in FIG. 1.

FIG. 3 is a diagram schematically showing an example of a form in which small particles are held by large particles constituting a first surface.

FIG. 4 is a diagram schematically showing a layer structure of the sample support of FIG. 1.

FIG. 5 is an SEM image showing a cross section of the sample support of FIG. 1.

FIG. 6 is an enlarged view of a portion including a region A1 of FIG. 5.

FIG. 7 is a diagram showing a second step in a mass spectrometry method using the sample support of FIG. 1.

FIG. 8 is a diagram showing a configuration example of a mass spectrometer that performs the mass spectrometry method.

FIG. 9 is a diagram showing an example of an irradiation region of micro-droplets in an example and a comparative example.

FIG. 10 is a diagram showing a measurement result of detection sensitivity per irradiation region in the example and the comparative example.

FIG. 11 is a diagram schematically showing a layer structure of a sample support according to a first modification.

FIG. 12 is a diagram schematically showing a layer structure of a sample support according to a second modification.

FIG. 13 is a diagram schematically showing a configuration example of large particles, small particles, and a conductive layer on a first surface of the sample support according to the second modification.

### DESCRIPTION OF EMBODIMENTS

Hereinafter, embodiments of the present invention will be described in detail with reference to the drawings. In the drawings, the same or corresponding parts are denoted by the same reference numerals, and redundant description will be omitted.

### [Sample Support]

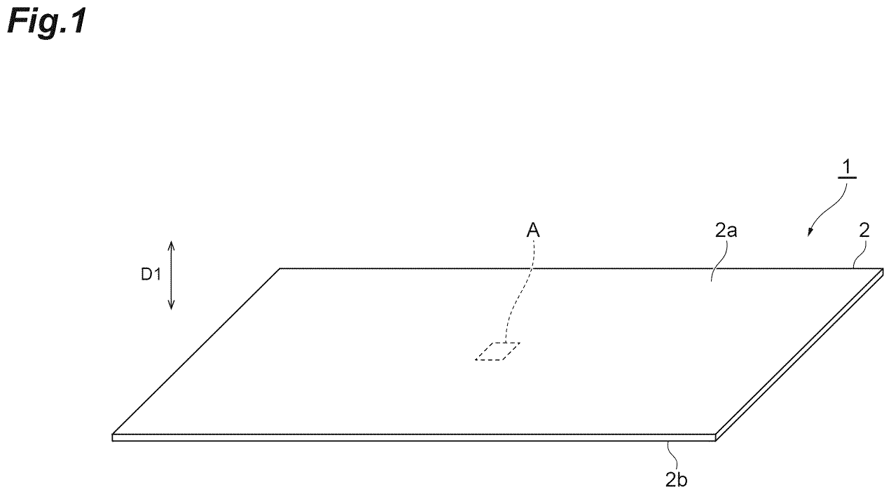

As shown in FIG. 1, a sample support 1 includes a substrate 2. As an example, the substrate 2 is formed in a rectangular plate shape. The substrate 2 has a first surface 2a and a second surface 2b opposite to the first surface 2a. The first surface 2a has insulating properties (electrical insulating properties). In the present embodiment, the substrate 2 is an insulating member. Therefore, not only the first surface 2a but also the entire substrate 2 has insulating properties. The thickness of the substrate 2 (distance from the first surface 2a to the second surface 2b) is, for example, about 100 μm to 1500 μm.

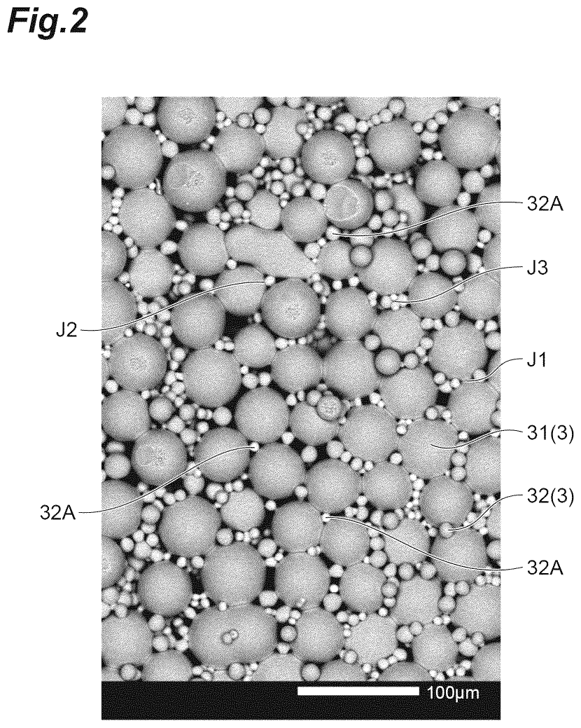

As shown in FIG. 2, an irregular porous structure 3 opening to the first surface 2a is formed in the substrate 2. In the present embodiment, the entire substrate 2 is formed of the porous structure 3. Here, the “irregular porous structure” is, for example, a structure in which voids (pores) extend in irregular directions and are irregularly distributed in three dimensions. For example, a structure that enters the substrate 2 from one inlet (opening) on the first surface 2a side and branches into a plurality of paths, or a structure that enters the substrate 2 from a plurality of inlets (openings) on the first surface 2a side and merges into one path is also included in the irregular porous structure. On the other hand, for example, a structure in which a plurality of pores extending along a thickness direction of the substrate 2 (that is, a direction D1 (first direction) in which the first surface 2a and the second surface 2b face each other) from the first surface 2a to the second surface 2b are provided as main pores (that is, a regular structure mainly configured by pores extending in one direction) is not included in the irregular porous structure.

The porous structure 3 is formed of an aggregate of a plurality of particles. The aggregate of a plurality of particles is a structure in which a plurality of particles are gathered so as to be in contact with each other. An example of the aggregate of a plurality of particles is a structure in which a plurality of particles are joined or bonded to each other. That is, in order to form a structure in which a plurality of particles are fixed in contact with each other, the plurality of particles may be directly connected by fusion or the like, or may be indirectly connected via another member. In the present embodiment, a plurality of particles are joined by fusion. In the present embodiment, the porous structure 3 is formed of a plurality of large particles 31 (first particles) connected to each other and a plurality of small particles 32 (second particles) having a diameter smaller than that of the large particles. The small particles 32 are formed of the same material as the large particles 31. In the present embodiment, the large particles 31 and the small particles 32 are formed of an insulating material. For example, the large particles 31 and the small particles 32 are formed of glass. In the present embodiment, from the viewpoint of facilitating the manufacture of the aggregate structure, soda glass having a relatively low melting point among glasses is used as the material of the large particles 31 and the small particles 32. The large particles 31 and the small particles 32 are both spherical beads (glass beads).

As shown in FIG. 2, in an SEM image captured from a direction facing the first surface 2a, although there are slight variations in shape and size for each particle, each of the plurality of particles constituting the porous structure 3 can be classified as either a large particle 31 or a small particle 32 even by visual observation. That is, the porous structure 3 is configured by a particle group that can be clearly distinguished into two groups in terms of “size”. More specifically, each of the plurality of large particles 31 has some variation in shape and size, but has a diameter larger than the small particles 32 to an extent that can be distinguished at least from the SEM image, and is distinguishable from the small particles 32. Similarly, each of the plurality of small particles 32 has some variation in shape and size, but has a diameter smaller than the large particles 31 to an extent that can be distinguished at least from the SEM image, and is distinguishable from the large particles 31.

When the first surface 2a is viewed from a position facing the first surface 2a along the direction D1, the following formula (1) is satisfied, where R1 is an average particle size of the large particles 31 included in a unit area of a predetermined size (for example, a region of several hundred μm to 1 mm square), and R2 is an average particle size of the small particles 32 included in the unit area. More preferably, the following formula (2) is satisfied.

$$R 1 \times 1 / 100 \leq R 2 \leq R 1 \times 1 / 2 \qquad ( 1 )$$

$$R 1 \times 1 / 10 \leq R 2 \leq R 1 \times 2 / 5 \qquad ( 2 )$$

The average particle sizes R1 and R2 can be calculated based on, for example, an SEM image as shown in FIG. 2. For example, first, all spherical objects are extracted by performing known image processing (edge detection or the like) on the SEM image of FIG. 2. The objects may be extracted by visual observation instead of the image processing. Subsequently, an object having a maximum diameter is extracted from the plurality of extracted objects, and objects having a diameter with an error of a certain value or less (for example, 30% or less of the maximum diameter) with respect to the maximum diameter are classified as the large particles 31. Subsequently, those of the plurality of objects that are not classified as the large particles 31 and remain are classified as the small particles 32. Subsequently, an average diameter of the plurality of objects classified as the large particles 31 is calculated as the average particle size R1 of the large particles 31, and an average diameter of the plurality of objects classified as the small particles 32 is calculated as the average particle size R2 of the small particles 32. The average particle sizes R1 and R2 can be calculated by the processing described above. The calculation method described above is an example, and the average particle sizes R1 and R2 may be calculated by other methods. As an example, the average particle size R1 of the large particles 31 is about 50 μm, and the average particle size R2 of the small particles 32 is about 5 μm to 20 μm.

As shown in FIG. 2, the first surface 2a of the substrate 2 is configured by surfaces (upper surfaces) of the large particles 31 and the small particles 32 located on the uppermost surface (outermost layer) when a direction from the second surface 2b toward the first surface 2a is defined as an upward direction. A black portion in FIG. 2 is a portion where the large particles 31 and the small particles 32 constituting the first surface 2a do not exist, and corresponds to a gap (opening) between the particles. When the first surface 2a is viewed from a position facing the first surface 2a along the direction D1, in a unit area of a predetermined size (for example, a region of several hundred μm to 1 mm square), it is preferable that an area occupied by the large particles 31 is the largest, and then an area occupied by the small particles 32 is larger than an area occupied by the gaps (openings) between the particles. The porous structure 3 is open to the first surface 2a at such openings. A liquid that has penetrated into the porous structure 3 from the openings of the first surface 2a can pass through the inside of the porous structure 3 and exit to the outside of the second surface 2b from openings on the second surface 2b side. That is, in the present embodiment, the porous structure 3 is open to both the first surface 2a and the second surface 2b, and the openings of the first surface 2a and the openings of the second surface 2b communicate with each other via the gaps between the particles inside the porous structure 3.

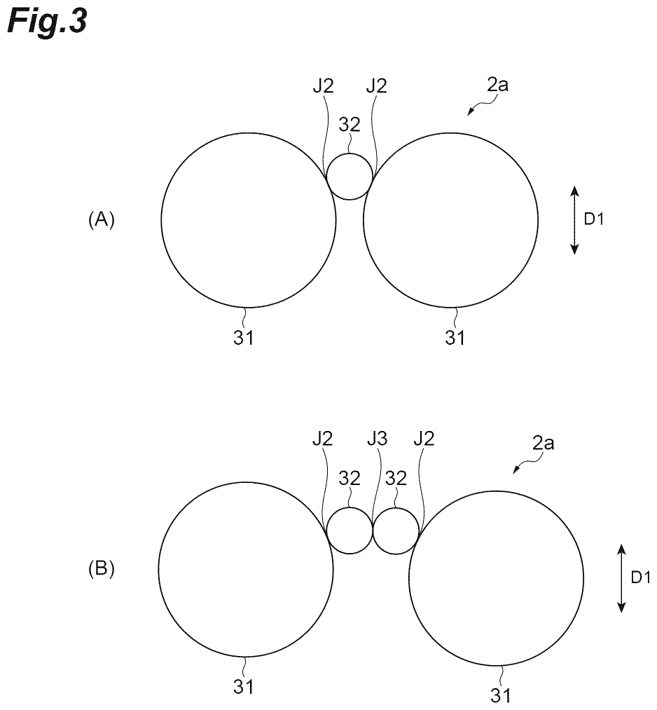

As shown in FIG. 2, at least a part of the plurality of small particles 32 included in the porous structure 3 is held between two or more of the large particles 31 constituting the first surface 2a (that is, the large particles 31 located on the uppermost surface). Examples of the form in which the small particles 32 are held by two or more of the large particles 31 constituting the first surface 2a include a form in which one small particle 32 is held between two large particles 31 as shown in (A) of FIG. 3, and a form in which a plurality of (two in this example) small particles 32 in contact with each other are held between two large particles 31 as shown in (B) of FIG. 3. However, the form in which the small particles 32 are held by two or more of the large particles 31 constituting the first surface 2a is not limited to the above examples. For example, as in some small particles 32A shown in FIG. 2, there may be a form in which one small particle 32A is held between three large particles 31. As shown in FIGS. 2 and 3, the porous structure 3 has a configuration in which one or more small particles 32 are held by two or more large particles 31 constituting the first surface 2a, thereby having a joint J1 between large particles 31, a joint J2 between a large particle 31 and a small particle 32, and a joint J3 between small particles 32 on the first surface 2a.

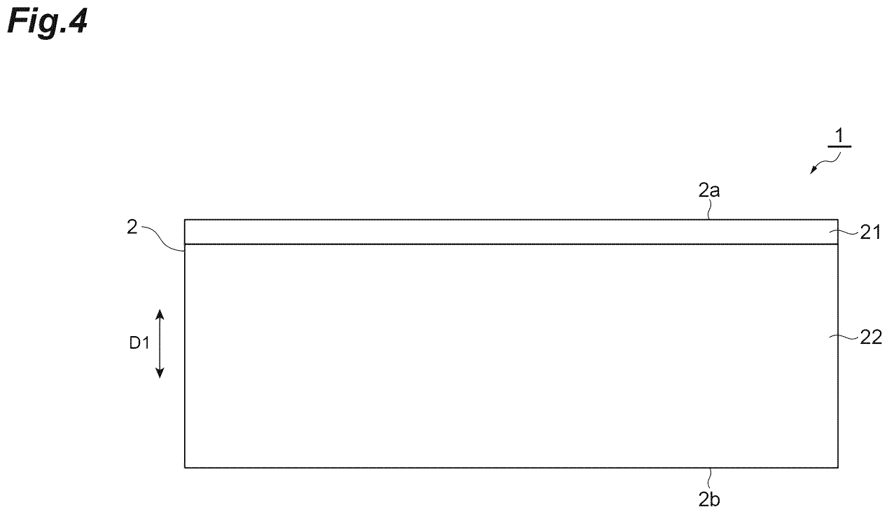

Here, most of the plurality of small particles 32 are distributed on the first surface 2a (that is, between the large particles 31 constituting the first surface 2a), and do not exist inside the substrate 2 (porous structure 3) at a position spaced a certain distance or more from the first surface 2a toward the second surface 2b. That is, as shown in FIG. 4, when a layer structure of the substrate 2 configured by the porous structure 3 is schematically represented, the substrate 2 has a mixed layer 21 (first layer) and a large particle layer 22 (second layer). The mixed layer 21 is a layer including the first surface 2a, in which a plurality of the large particles 31 and a plurality of the small particles 32 coexist. The large particle layer 22 is a layer located closer to the second surface 2b than the mixed layer 21, consisting of a plurality of the large particles 31, and not including the small particles 32.

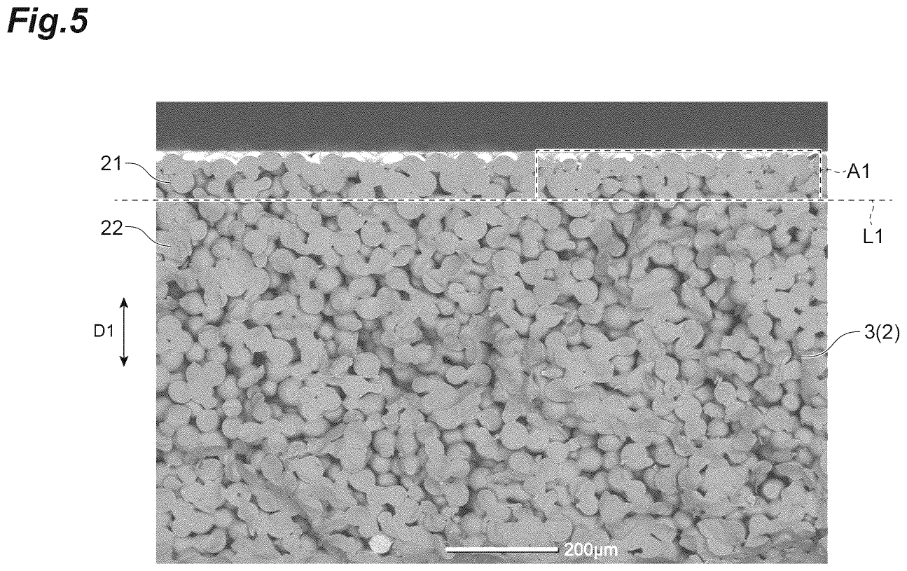

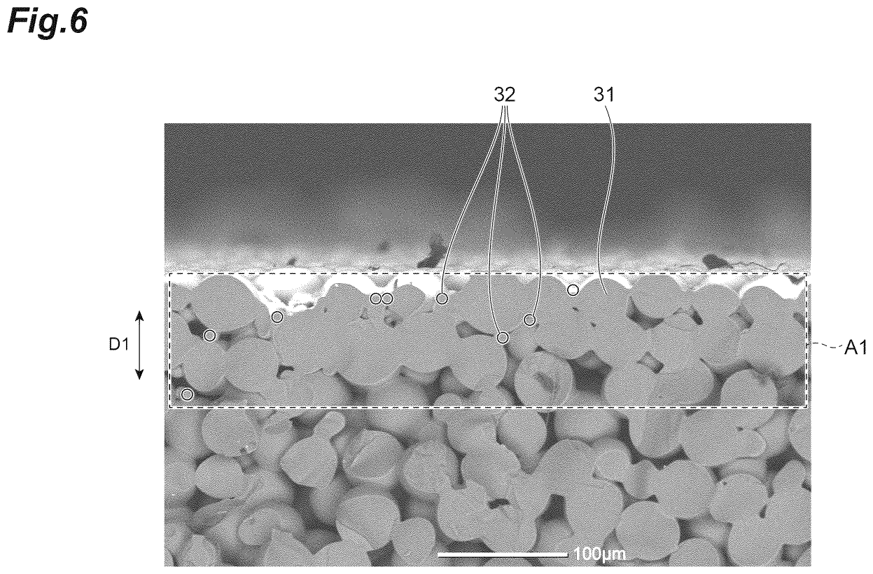

FIG. 5 is an SEM image of a cross section of a portion including the mixed layer 21 and a part of the large particle layer 22 (a portion adjacent to the mixed layer 21) of the substrate 2. FIG. 6 is an enlarged view of a portion including a region A1 shown in FIG. 5. In FIG. 6, reference numerals are given only to some of the small particles 32 confirmed in the cross section of the region A1. In the examples shown in FIGS. 5 and 6, when the large particles 31 located in the outermost layer (that is, the large particles 31 constituting the first surface 2a) are regarded as a first layer, a portion from the first surface 2a to the second to third layers constitutes the mixed layer 21. That is, in this example, a portion above a line L1 shown in FIG. 5 (on the first surface 2a side) constitutes the mixed layer 21, and a portion below the line L1 (on the second surface 2b side) constitutes the large particle layer 22. In the present embodiment, as can be seen from FIGS. 5 and 6, substantially only the plurality of large particles 31 are in contact with a virtual plane constituting the outermost surface of the first surface 2a (that is, a plane along an upper line of the region A1). In other words, the small particles 32 are held between the large particles 31 with a size and an amount such that they do not contact the virtual plane.

A thickness of the mixed layer 21 in the direction D1 is one-fifth or less of a thickness of the large particle layer 22 in the direction D1. In the present embodiment, as an example, the thickness of the mixed layer 21 is about one-tenth of the total thickness of the substrate 2 (porous structure 3). That is, the thickness of the mixed layer 21 is about one-ninth of the thickness of the large particle layer 22.

### [Method for Manufacturing Sample Support]

The sample support 1 (porous structure 3) is manufactured, for example, as follows. First, a plurality of large particles 31 are sintered to obtain a sintered body (first sintering step). Specifically, in a state where the plurality of large particles 31 are pressed and compacted by a press machine or the like, the surfaces of the plurality of large particles 31 are fused by being heated at a high temperature equal to or lower than the melting point of the large particles 31, whereby a sintered body consisting only of the plurality of large particles 31 is obtained. The sintered body has substantially the same outer shape as the finally obtained substrate 2. Subsequently, a plurality of small particles 32 are added to a surface of the sintered body corresponding to the first surface 2a (that is, a surface scheduled to finally become the first surface 2a) (adding step). For example, the plurality of small particles 32 are sprinkled on the surface of the sintered body. Subsequently, by sintering (re-sintering) in a state where the sintered body and the plurality of small particles 32 added to the sintered body coexist, the porous structure 3 in which the surfaces of the plurality of large particles 31 and the plurality of small particles 32 are fused together is obtained (second sintering step).

However, the method for manufacturing the sample support 1 is not limited to the above method. For example, the sample support 1 (porous structure 3) may be manufactured by a single sintering step in a state where a plurality of the large particles 31 and a plurality of the small particles 32 coexist. However, in a state where the plurality of large particles 31 are not fixed (sintered), a large number of the small particles 32 are also included inside the sintered body (that is, inside the substrate 2), and the large particle layer 22 described above may not be suitably formed. Therefore, from the viewpoint of reliably and easily obtaining the layer structure described above (that is, the mixed layer 21 and the large particle layer 22), it is preferable to obtain the sample support 1 (porous structure 3) by the two-step sintering process as described above. The sample support 1 manufactured by the manufacturing method described above (the first sintering step, the adding step, and the second sintering step) can also be regarded as having a structure in which a plurality of small particles 32 as separate members from the substrate are added to the first surface of the substrate as a sintered body formed by the plurality of large particles 31 so as to be able to maintain a certain outer shape. That is, the plurality of large particles 31 can be regarded as elements constituting the substrate 2 of the sample support 1, and the plurality of small particles 32 can be regarded as elements added (filled) to a part including the first surface 2a of the substrate 2 in order to increase the surface area and joints (joints J2, J3) of the first surface 2a of such a substrate 2 (the plurality of large particles 31).

### [Ionization Method and Mass Spectrometry Method]

An ionization method and a mass spectrometry method using the sample support 1 will be described. First, the sample support 1 described above is prepared as a sample support for ionizing a sample (first step). The sample support 1 may be prepared by being manufactured by a person who performs the ionization method and the mass spectrometry method, or may be prepared by being transferred from a manufacturer, a seller, or the like of the sample support 1.

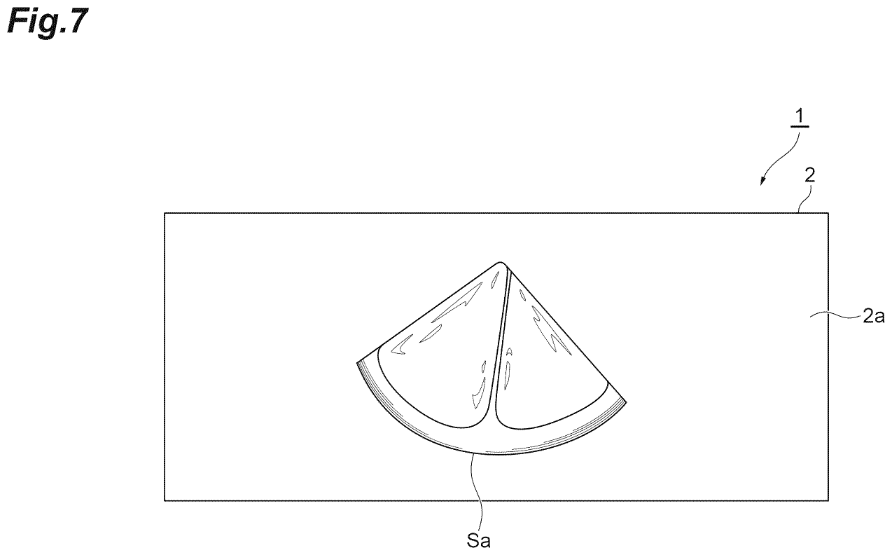

Subsequently, as shown in FIG. 7, a sample Sa is transferred to the first surface 2a of the substrate 2 (second step). In the example of FIG. 7, the sample Sa is a slice of a fruit (lemon). For example, a part of the sample Sa is attached onto the first surface 2a by pressing the sample Sa against the first surface 2a of the substrate 2.

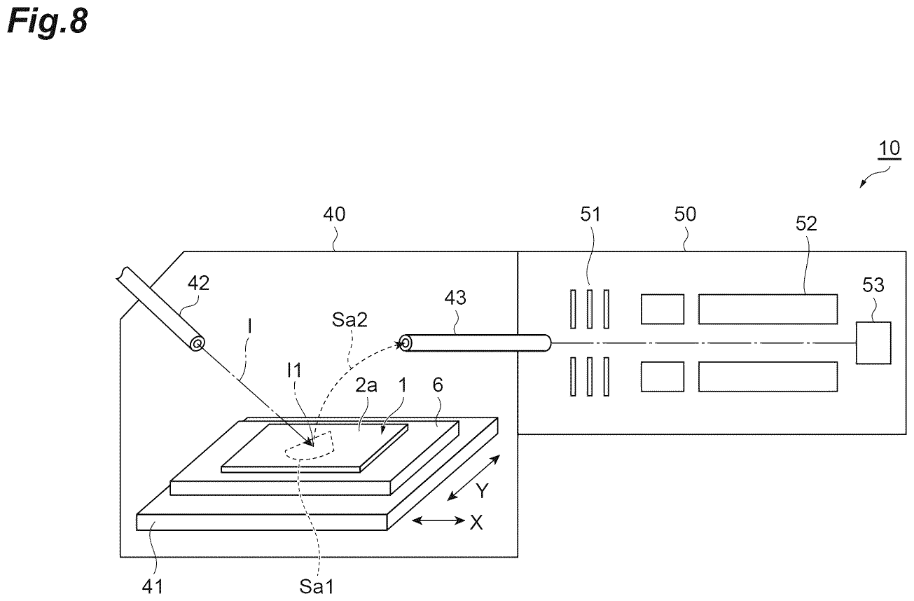

Subsequently, as shown in FIG. 8, a slide glass 6 and the sample support 1 are placed on a stage 41 in an ionization chamber 40 of a mass spectrometer 10. Subsequently, a region including a region where the transferred sample Sa exists on the first surface 2a of the substrate 2 (hereinafter referred to as a “target region”) is irradiated with charged micro-droplets I, thereby ionizing a component Sa1 on the first surface 2a and sucking a sample ion Sa2, which is an ionized component (third step).

In the present embodiment, for example, by moving the stage 41 in an X-axis direction and a Y-axis direction, an irradiation region I1 of the charged micro-droplets I is relatively moved with respect to the target region (that is, the target region is scanned with the charged micro-droplets I). The first step, the second step, and the third step described above correspond to an ionization method (in the present embodiment, a desorption electrospray ionization method) using the sample support 1.

In the ionization chamber 40, charged micro-droplets I are ejected from a nozzle 42, and sample ions Sa2 are sucked from a suction port of an ion transport tube 43. The nozzle 42 has a double-tube structure. A solvent is guided to an inner tube of the nozzle 42 in a state where a high voltage is applied. As a result, a biased charge is applied to the solvent that has reached a tip of the nozzle 42. A nebulizing gas is guided to an outer tube of the nozzle 42. As a result, the solvent is sprayed as micro-droplets, and solvent ions generated in the process of vaporizing the solvent are emitted as the charged micro-droplets I.

The sample ions Sa2 sucked from the suction port of the ion transport tube 43 are transported into a mass analysis chamber 50 by the ion transport tube 43. The inside of the mass analysis chamber 50 is under a high vacuum atmosphere (an atmosphere with a degree of vacuum of 104 Torr or less). In the mass analysis chamber 50, the sample ions Sa2 are focused by an ion optical system 51 and introduced into a quadrupole mass filter 52 to which a high-frequency voltage is applied. When the sample ions Sa2 are introduced into the quadrupole mass filter 52 to which the high-frequency voltage is applied, ions having a mass number determined by a frequency of the high-frequency voltage are selectively passed, and the passed ions are detected by a detector 53 (fourth step). By scanning the frequency of the high-frequency voltage applied to the quadrupole mass filter 52, the mass number of ions reaching the detector 53 is sequentially changed to obtain a mass spectrum in a predetermined mass range. In the present embodiment, the detector 53 is caused to detect ions corresponding to the position of the irradiation region I1 of the charged micro-droplets I, and a two-dimensional distribution of molecules constituting the sample Sa is imaged. The first step, the second step, the third step, and the fourth step described above correspond to a mass spectrometry method using the sample support 1.

### Effects

In the sample support 1 described above, the porous structure 3 includes not only the plurality of large particles 31 but also the small particles 32 held between two or more of the large particles 31 constituting the first surface 2a. This can reduce a gap (that is, a space where no particles constituting the porous structure 3 exist) of the sample support 1 on the first surface 2a when the sample support 1 is viewed from a direction facing the first surface 2a. That is, as can be seen from the SEM image of FIG. 2, the gaps between the large particles 31 in the outermost layer are filled by holding the plurality of small particles 32 between the plurality of large particles 31 in the outermost layer. In addition, as shown in FIG. 2, on the first surface 2a, not only a joint J1 between the large particles 31 but also a joint J2 between the large particle 31 and the small particle 32 and a joint J3 between the small particles 32 are also formed. The sample Sa transferred or dropped onto the first surface 2a is particularly likely to be retained at such joints J1, J2, and J3. That is, by increasing such joints J1, J2, and J3, the sample Sa to be measured can be suitably retained on the first surface 2a (particularly on the joints J1, J2, and J3 described above). Therefore, according to the sample support 1, since a component Sa1 of the sample Sa retained on the first surface 2a can be efficiently ionized, the detection sensitivity of the component Sa1 of the sample Sa (that is, the detection sensitivity of the sample ion Sa2) in mass spectrometry using the sample support 1 (for example, the first to fourth steps in the above embodiment) can be effectively improved. Furthermore, since the sample Sa is easily retained on the first surface 2a as described above, a region where the sample Sa is stained on the first surface 2a becomes larger and the stain becomes darker. This improves the visibility of the sample Sa attached to the measurement surface (first surface 2a) of the sample support 1, and also facilitates work such as determining an irradiation range of the micro-droplets I for ionization.

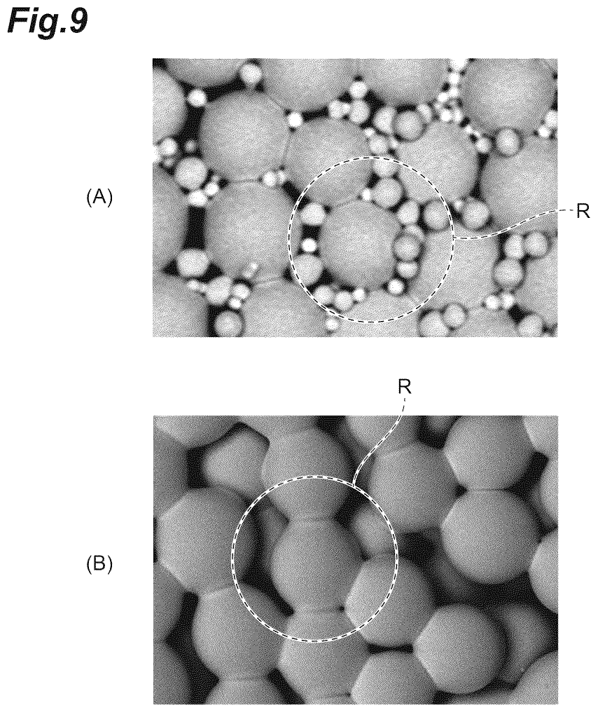

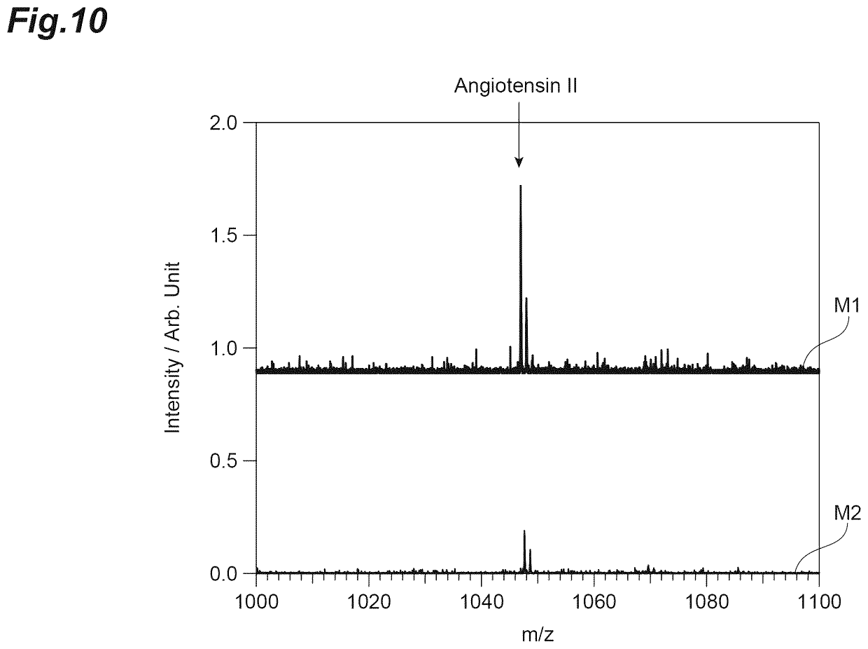

The above effects will be supplemented with reference to FIGS. 9 and 10. In the examples of FIGS. 9 and 10, by providing a conductive layer 4 described later, laser desorption/ionization, in which ionization is performed by irradiating a laser beam instead of the micro-droplets I, is used instead of the desorption electrospray ionization method of the above embodiment. However, (A) and (B) of FIG. 9 show states before the conductive layer 4 is provided in an example and a comparative example. (A) of FIG. 9 shows an example of one irradiation range R of a laser beam in the example (that is, a sample support 1B including a conductive layer 4 described later). (B) of FIG. 9 shows an example of one irradiation range R of a laser beam in the comparative example. The sample support according to the comparative example has a substrate (porous structure) configured only by a plurality of the large particles 31, and is different from the example in that it does not include a plurality of the small particles 32. FIG. 10 shows mass spectra obtained by performing mass spectrometry (laser desorption/ionization method) of a sample Sa (as an example, Angiotensin II) using each of the above example and comparative example. That is, in FIG. 10, a horizontal axis represents a mass-to-charge ratio (m/z), and a vertical axis represents a signal intensity (arbitrary unit: arb. unit). FIG. 10 shows a mass spectrum M1 of the example and a mass spectrum M2 of the comparative example. In order to facilitate comparison between the mass spectrum M1 of the example and the mass spectrum M2 of the comparative example, an origin of the signal intensity of the mass spectrum M1 of the example (that is, a value corresponding to a signal intensity “0”) is shifted upward (by about +0.8). The mass spectra M1 and M2 are normalized with a peak intensity of sodium citrate in each of the example and the comparative example as 100% (1.0). As shown in FIG. 10, according to the example, a higher signal intensity was obtained at a position corresponding to the sample Sa (Angiotensin II) than in the comparative example. That is, it was confirmed that according to the example, since the component Sa1 of the sample Sa is more easily retained on the first surface 2a than in the comparative example, the detection sensitivity of the component Sa1 of the sample Sa is remarkably improved. As described above, FIG. 10 shows a measurement result when the laser desorption/ionization method is performed using the sample support including the conductive layer 4, but it is considered that a similar result can be obtained even when mass spectrometry by the desorption electrospray ionization method described above (the first to fourth steps described above) is performed using a sample support not including the conductive layer 4. That is, since the component Sa1 of the sample Sa is more easily retained on the first surface 2a in the example (sample support 1) than in the comparative example (that is, a sample support having a substrate (porous structure) configured only by a plurality of the large particles 31 and not including a plurality of the small particles 32), it is considered that high detection sensitivity can be obtained in the mass spectrometry by the desorption electrospray ionization method described above (the first to fourth steps described above).

In the sample support 1, the small particles 32 are formed of the same material as the large particles 31. If the large particles 31 and the small particles 32 are formed of different materials from each other, a signal derived from a material (material of the small particles 32) different from a base material (material of the large particles 31) may be generated as noise during ionization (in the present embodiment, during ionization of the component Sa1 by irradiation with the micro-droplets I). In contrast, by forming the large particles 31 and the small particles 32 of the same material as in the present embodiment, the occurrence of such a problem can be avoided. In addition, since the melting points and the coefficients of thermal expansion of the large particles 31 and the small particles 32 are equal, the second sintering step described above can be easily performed (that is, can be performed under the same temperature conditions as the first sintering step), so that the substrate 2 (porous structure 3) can be manufactured easily and with stable quality.

In the sample support 1, the large particles 31 and the small particles 32 are formed of an insulating material. According to this configuration, the substrate 2 in which the plurality of large particles 31 and the plurality of small particles 32 are integrated can be manufactured by a simple method such as sintering. In addition, since the substrate 2 can be made insulating, the sample support 1 suitable for the desorption electrospray ionization method described above can be realized. In the present embodiment, the large particles 31 and the small particles 32 are formed of glass. According to this configuration, by forming the large particles 31 and the small particles 32 with glass having a relatively low melting point, a heating temperature required for the first sintering step and the second sintering step described above can be relatively lowered, so that the substrate 2 having the porous structure 3 can be suitably and inexpensively obtained.

In the sample support 1, the sizes of the plurality of large particles 31 and the plurality of small particles 32 included in the porous structure 3 are adjusted so as to satisfy the above formula (1) (that is, “R1× 1/100≤R2≤R1×½”). According to this configuration, a configuration in which one or more small particles 32 are held between two or more large particles 31 constituting the first surface 2a can be suitably realized. As a result, the effect of improving the detection sensitivity as described above can be suitably obtained. From the viewpoint of more suitably realizing the configuration in which the small particles 32 are held between the large particles 31 as described above, it is more preferable to satisfy the above formula (2) (that is, “R1× 1/10≤R2≤R1×⅖”).

In the sample support 1, the substrate 2 has the mixed layer 21 including the first surface 2a, and the large particle layer 22 located on the second surface 2b side with respect to the mixed layer 21. That is, in the sample support 1, while the mixed layer 21 in which the large particles 31 and the small particles 32 are mixed is provided to easily retain the sample Sa on the first surface 2a, the large particle layer 22, through which a liquid can pass more easily than the mixed layer 21 by not including the small particles 32, is provided below the mixed layer 21 (on the second surface 2b side). This allows the liquid component to appropriately escape from the mixed layer 21 to the large particle layer 22, for example, when a sample Sa to be measured containing a liquid component is transferred or dropped onto the first surface 2a of the sample support 1. As a result, it is possible to suppress an excess liquid component from overflowing on the first surface 2a, and to suppress the measurement (that is, ionization of the component Sa1 of the sample Sa retained on the first surface 2a) from being hindered by the generation of such an excess liquid component.

In the sample support 1, a thickness of the mixed layer 21 in the direction D1 is one-fifth or less of a thickness of the large particle layer 22 in the direction D1. According to this configuration, by sufficiently securing the thickness of the large particle layer 22 with respect to the mixed layer 21, the effect described above (that is, the effect of allowing a liquid component that may hinder measurement to escape from the mixed layer 21 to the large particle layer 22) can be suitably obtained.

In addition, the method for manufacturing the sample support 1 includes the first sintering step, the adding step, and the second sintering step described above. According to such a manufacturing method, a highly reliable porous structure 3 can be obtained by performing a two-step sintering process. That is, by first obtaining a structure having high strength and stability only with the plurality of large particles 31 (that is, a portion constituting a framework of the porous structure 3) in the first sintering step, and then performing the adding step and the second sintering step, the sample support 1 exhibiting the effects as described above can be easily and stably obtained.

In the ionization method described above, in the third step, the irradiation region I1 of the charged micro-droplets I is relatively moved with respect to the first surface 2a. In the component Sa1 of the sample Sa retained on the first surface 2a side of the substrate 2, position information of the sample Sa (two-dimensional distribution information of molecules (component Sa1) constituting the sample Sa) is maintained. Therefore, by relatively moving the irradiation region I1 of the charged micro-droplets I with respect to the first surface 2a (target region), the component Sa1 of the sample Sa can be ionized while maintaining the position information of the sample Sa. This makes it possible to image the two-dimensional distribution of the molecules constituting the sample Sa in a subsequent step of detecting the sample ions Sa2. Furthermore, since the nozzle 42 can be brought close to the first surface 2a as described above, it is possible to suppress the irradiation region I1 of the charged micro-droplets I from expanding. This makes it possible to image the two-dimensional distribution of the molecules constituting the sample Sa with high resolution in a subsequent step of detecting the sample ions Sa2.

In the mass spectrometry method using the sample support 1, as described above, since the component Sa1 of the sample Sa is suitably ionized by irradiation with the charged micro-droplets I, the signal intensity when detecting the sample ions Sa2 can be improved.

### Modifications

The present disclosure is not limited to the embodiments described above. Various materials and shapes can be adopted for the material and shape of each component, not limited to the materials and shapes described above. In addition, some of the configurations included in the sample support 1 according to the above embodiment may be omitted or changed as appropriate. For example, in the above embodiment, some characteristic configurations included in the sample support 1 and some effects exhibited by each configuration have been described, but the sample support according to the present disclosure does not necessarily have to be configured to exhibit all the effects described in the above embodiment, and may be configured to exhibit only some of the effects described in the above embodiment. In the latter case, the sample support only needs to be provided with a configuration essential for exhibiting that part of the effects, and a configuration not essential for exhibiting that part of the effects may be omitted or changed as appropriate. When focusing on one effect, the configuration essential for exhibiting the one effect should be reasonably grasped by a person skillied in the art based on common general knowledge and the description of the present specification. Hereinafter, some specific modifications of the sample support of the present disclosure will be exemplified.

### First Modification

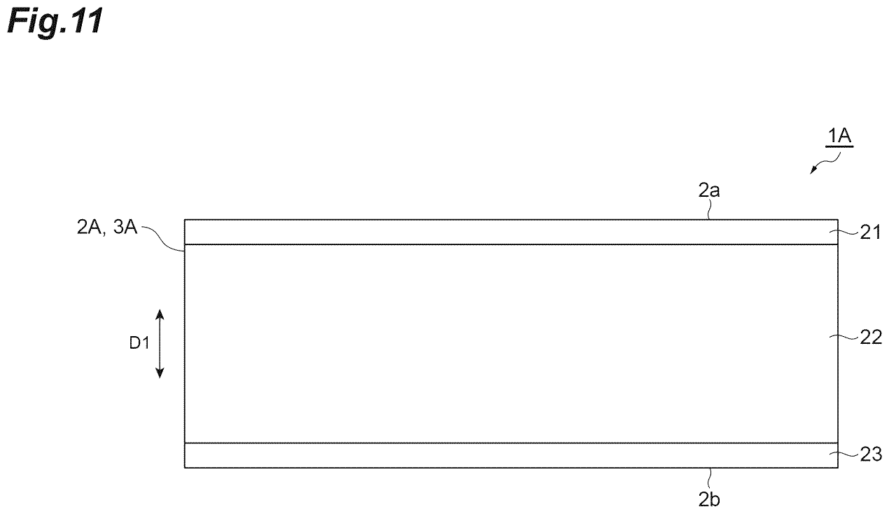

A sample support 1A according to a first modification will be described with reference to FIG. 11. The sample support 1A is different from the sample support 1 in that it has a symmetrical structure in the direction D1, that is, a portion on the first surface 2a side and a portion on the second surface 2b side have the same configuration, and both the first surface 2a and the second surface 2b are configured to be usable as a measurement surface (a surface on which the sample Sa is transferred or dropped).

That is, a substrate 2A (porous structure 3A) of the sample support 1A includes a mixed layer 23 (third layer) including the second surface 2b, in which a plurality of the large particles 31 and a plurality of the small particles 32 are mixed, and the large particle layer 22 is located between the mixed layer 21 and the mixed layer 23. The second surface 2b is configured similarly to the first surface 2a. That is, at least a part of the plurality of small particles 32 included in the mixed layer 23 is held between two or more of the large particles 31 constituting the second surface 2b.

According to the sample support 1A, both the first surface 2a and the second surface 2b can be used as a measurement surface (that is, a surface that supports the sample Sa to be measured). This improves convenience because a user of the sample support 1A (that is, a measurer who performs measurement using the sample support 1A) does not need to identify which surface of the sample support 1A is the measurement surface when transferring or dropping the sample Sa to be measured onto the sample support 1A.

### Second Modification

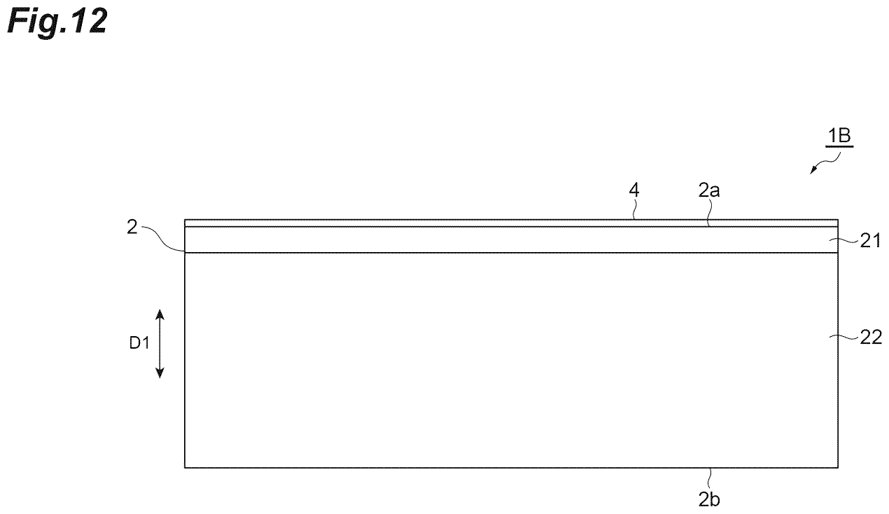

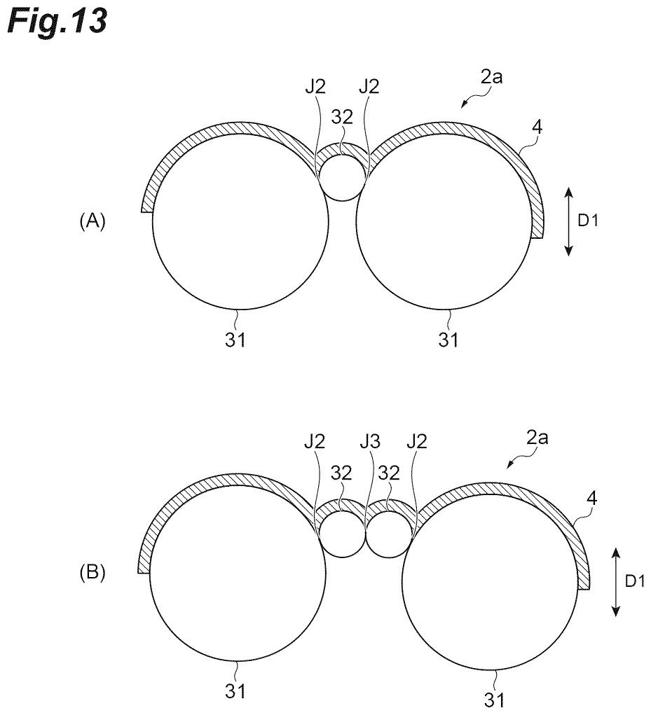

A sample support 1B according to a second modification will be described with reference to FIGS. 12 and 13. The sample support 1B is different from the sample support 1 in that it includes a conductive layer 4. The sample support 1B, by including the conductive layer 4, can be used for an ionization method (for example, a laser desorption/ionization method, or the like) that requires applying a voltage on the first surface 2a to detect the component Sa1 of the ionized sample Sa.

The conductive layer 4 covers the first surface 2a without blocking the openings of the porous structure 3 on the first surface 2a. That is, the conductive layer 4 is provided so as not to completely block the openings (gaps between particles) of the porous structure 3 on the first surface 2a. As a result, also in the sample support 1B, a liquid component contained in the sample Sa transferred or dropped onto the first surface 2a (strictly speaking, onto the conductive layer 4 formed on the first surface 2a) can penetrate into the porous structure 3 and escape to the large particle layer 22. That is, in the sample support 1B, for example, as compared with a case where the conductive layer 4 is formed on a substrate configured only by the large particles 31, the conductive layer 4 is also formed on the surfaces of the small particles 32, whereby a more continuous conductive layer 4 can be formed and conductivity on the first surface 2a can be suitably secured. In addition, the conductive layer 4 is in a state where a gap is provided to an extent that at least the liquid component contained in the sample Sa can escape to the large particle layer 22.

In addition, the conductive layer 4 covers the first surface 2a along an uneven shape (for example, a recessed shape at the joints J1, J2, and J3) of the first surface 2a configured by the large particles 31 and the small particles 32. That is, a thickness of the conductive layer 4 is made very thin with respect to the sizes (diameters) of the large particles 31 and the small particles 32. As a result, a shape of an outer surface of the conductive layer 4 formed on the surfaces of the large particles 31 and the small particles 32 follows the original surface shapes of the large particles 31 and the small particles 32. Therefore, as shown in FIG. 13, even in a state after the conductive layer 4 is formed, the uneven shape of the first surface 2a (particularly, the recessed shape of the joints J1, J2, and J3) is maintained.

The conductive layer 4 is formed of a conductive material. As a material of the conductive layer 4, it is preferable to use a metal having low affinity (reactivity) with the sample Sa and high conductivity. From such a viewpoint, as the material of the conductive layer 4, for example, Au (gold), Pt (platinum), or the like is preferably used. The conductive layer 4 is formed to a thickness of about 1 nm to 350 nm by, for example, a plating method, an atomic layer deposition (ALD) method, a vapor deposition method, a sputtering method, or the like. Note that, as the material of the conductive layer 4, for example, Cr (chromium), Ni (nickel), Ti (titanium), or the like may be used.

As in the examples shown in (A) and (B) of FIG. 13, the conductive layer 4 is formed to cover surfaces exposed on the first surface 2a side among the surfaces of the large particles 31 and the small particles 32 constituting the first surface 2a, for example, by performing the vapor deposition method, the sputtering method, or the like described above from the first surface 2a side. On the other hand, when the conductive layer 4 is formed by ALD, the conductive layer 4 enters the gaps of the porous structure 3, and thus can be formed not only on the surfaces exposed on the first surface 2a side but also on surfaces of the large particles 31 and the small particles 32 facing the second surface 2b side. That is, the conductive layer 4 may be formed to cover at least the surfaces exposed on the first surface 2a side among the surfaces of the large particles 31 and the small particles 32 constituting the first surface 2a, and may be provided to cover the entire surfaces of the large particles 31 and the small particles 32 constituting the first surface 2a.

According to the sample support 1B, it is possible to obtain the same effects as the sample support 1 (that is, without impairing the effects of the sample support 1 due to the presence of the conductive layer 4), and the sample support 1B can be used for a laser desorption/ionization method or the like. More specifically, when a laser desorption/ionization method or the like is used, that is, when it is necessary to apply a voltage to the first surface 2a to guide the component Sa1 of the sample Sa ionized on the first surface 2a to an ion detector (ground electrode side), a voltage can be appropriately applied via the conductive layer 4.

### Other Modifications

The configurations of the above-described embodiment, the first modification, and the second modification may be combined as appropriate. For example, the first modification and the second modification may be combined. In this case, the conductive layer 4 is provided on each of the first surface 2a and the second surface 2b of the sample support 1A.

In the above embodiment, the porous structure 3 has a configuration in which the small particles 32 are held between two or more of the large particles 31 constituting the first surface 2a by fusing the large particles 31 and the small particles 32 to each other, but the small particles 32 do not necessarily have to be fused with the adjacent large particles 31.

In the above embodiment, the sample support 1 was configured to include only the substrate 2, but the sample support 1 may include members other than the substrate 2. For example, a support member (a frame or the like) for supporting the substrate 2 may be provided at a part (for example, a corner or the like) of the substrate 2.

The sample Sa is not limited to the slice of the fruit (lemon) exemplified in the above embodiment. The sample Sa may have a flat surface or an uneven surface. The sample Sa may be other than a fruit, and may be, for example, a leaf of a plant or the like. In this case, by transferring components of the surface of the leaf, which is the sample Sa, to the first surface 2a, imaging mass spectrometry of the surface (leaf vein) of the leaf can be performed.

In the above embodiment, the entire substrate 2 is configured by the porous structure 3, but the porous structure 3 may be formed in a part of the substrate 2. For example, the porous structure 3 may be formed only in a central region (a partial region of the first surface 2a) defined as a measurement region for transferring or dropping the sample Sa in the substrate 2. In this case, the porous structure 3 may not be formed in other portions of the substrate 2. In addition, the porous structure 3 does not have to be formed over the entire region from the first surface 2a to the second surface 2b. That is, the porous structure 3 only needs to be open to at least the first surface 2a, and does not have to be open to the second surface 2b. For example, the substrate 2 may be configured by a flat plate including the second surface 2b, and the porous structure 3 provided on a surface of the plate opposite to the second surface 2b. As an example, the substrate 2 may be configured by a glass plate and a sintered body of glass beads (porous structure 3) provided on the glass plate.

In the above embodiment, the first surface 2a had insulating properties so that the sample support 1 can be used for a desorption electrospray ionization method. More specifically, the substrate 2 (porous structure 3) itself was formed of an insulating material, so that the first surface 2a had insulating properties. However, the sample support 1 can be configured to be usable for the desorption electrospray ionization method by a configuration other than the above. For example, the substrate 2 (porous structure 3) may be formed of a conductive material. In this case, a configuration in which the first surface 2a has insulating properties may be realized by applying an insulating coating to the first surface 2a of the substrate 2. By applying such an insulating coating, the first surface 2a of the substrate 2 can be made insulating, so that it becomes possible to use the substrate 2 formed of a conductive material. For example, in this case, the porous structure 3 may be formed by an aggregate of a plurality of particles (the large particles 31 and the small particles 32) made of metal. As described above, when an insulating coating is provided, the degree of freedom in selecting a substrate material (that is, a material of the large particles 31 and the small particles 32) can be improved.

As a material of the large particles 31 and the small particles 32 constituting the porous structure 3, in addition to the insulating material exemplified in the above embodiment (as an example in the above embodiment, glass (soda glass)), a metal oxide (for example, alumina or the like), or an insulating-coated metal or the like may be used. The shapes of the large particles 31 and the small particles 32 constituting the porous structure 3 are not limited to a spherical shape, and may have a shape other than a spherical shape. In the latter case, the diameter (average particle sizes R1, R2) of the particles (the large particles 31 or the small particles 32) described in the above embodiment may be interpreted as an effective diameter of the particles observed when the substrate 2 is viewed from a position facing the first surface 2a along the direction D1 (that is, a maximum diameter of a virtual cylinder that is inscribed in a region occupied by the particles).

### REFERENCE SIGNS LIST

1, 1A, 1B: sample support, 2, 2A: substrate, 2a: first surface, 2b: second surface, 3, 3A: porous structure, 4: conductive layer, 21: mixed layer (first layer), 22: large particle layer (second layer), 23: mixed layer (third layer), 31: large particle (first particle), 32, 32A: small particle (second particle), J1, J2, J3: joint, Sa: sample, Sa1: component, Sa2: sample ion (ionized component).

1: A sample support for ionizing a sample, comprising:
a substrate having a first surface, a second surface opposite to the first surface, and an irregular porous structure opening to at least the first surface,
wherein the porous structure is formed of a plurality of first particles connected to each other and a plurality of second particles having a diameter smaller than that of the first particles, and
at least a part of the plurality of second particles is held between two or more of the first particles constituting the first surface.

2: The sample support according to claim 1, wherein the second particles are formed of a same material as the first particles.

3: The sample support according to claim 2, wherein the first particles and the second particles are formed of an insulating material.

4: The sample support according to claim 3, wherein the insulating material is glass.

5: The sample support according to claim 1, wherein
when the first surface is viewed from a position facing the first surface along a direction in which the first surface and the second surface face each other, the following formula (1) is satisfied, where R1 is an average particle size of the first particles included in a unit area of a predetermined size, and R2 is an average particle size of the second particles included in the unit area:
$$R 1 \times 1 / 100 \leq R 2 \leq R 1 \times 1 / 2 . \qquad ( 1 )$$

6: The sample support according to claim 1, wherein the substrate comprises:
a first layer including the first surface, in which a plurality of the first particles and a plurality of the second particles coexist; and
a second layer located closer to the second surface than the first layer, consisting of a plurality of the first particles, and not including the second particles.

7: The sample support according to claim 6, wherein a thickness of the first layer in a first direction in which the first surface and the second surface face each other is one-fifth or less of a thickness of the second layer in the first direction.

8: The sample support according to claim 6, wherein
the substrate further comprises a third layer including the second surface, in which a plurality of the first particles and a plurality of the second particles coexist,
the second layer is located between the first layer and the third layer, and
at least a part of the plurality of second particles included in the third layer is held between two or more of the first particles constituting the second surface.

9: The sample support according to claim 1, further comprising a conductive layer that covers the first surface along an uneven shape of the first surface configured by the first particles and the second particles, without blocking openings of the porous structure on the first surface.

10: A method for manufacturing the sample support according to claim 1, comprising:
a first sintering step of sintering the plurality of first particles to obtain a sintered body having substantially same outer shape as the substrate;
an adding step of adding the plurality of second particles to a surface of the sintered body corresponding to the first surface; and
a second sintering step of sintering the sintered body and the plurality of second particles obtained by the adding step to obtain the porous structure.
